(19) United States
(12) Patent Application Publication
(10) Pub. No.: US 2026/0318297 A1
(43) Pub. Date: Oct. 15, 2026

(54) PROTECTIVE SLEEVE FOR PLUNGER REMOVAL AND INSTALLATION

(71) Applicant: Kerr Machine Co., Sulphur, OK (US)

(72) Inventors: Christopher Todd Barnett, Ada, OK (US); Nicholas Son, Roff, OK (US); John Keith, Duncan, OK (US); Kelcy Jake Foster, Sulphur, OK (US); Jon Robert Vaughn, Sulphur, OK (US)

(21) Appl. No.: 19/637,339

(22) Filed: Apr. 2, 2026

Related U.S. Application Data
(60) Provisional application No. 63/785,724, filed on Apr. 9, 2025.

(51) Int. Cl. F04B 53/22; B23Q 3/00

(52) U.S. Cl. CPC F04B 53/22; B23Q 3/005

(57) ABSTRACT

A sleeve for use during maintenance, installation, and reinstallation of fluid end parts such as plungers. The sleeve is made of a softer material than the housing and hardened insert, such as a less expensive thermoplastic that is easier and cheaper to produce than metal. A method of using the sleeve might include removing a retainer from a bore, inserting the sleeve, removing the plunger such that the sleeve guards the plunger from contacting or damaging the bore, completing maintenance, then reinserting the plunger or a new plunger into the bore through the sleeve.

### FIELD OF INVENTION

This invention relates to tools used in high-pressure pump systems, specifically a protective sleeve composed of a cylindrical body designed to prevent damage to vulnerable features within the flow bore of the fluid end and the plunger during plunger removal and reinstallation during in-field maintenance.

### BACKGROUND

Fluid ends used in high-pressure pump systems define one or more bores through which plungers reciprocate during operation. Fluid end assemblies are commonly used in oil and gas operations to deliver pressurized fluids to piping or wellbore systems. Such bores may include one or more threaded regions, sealing surfaces, insert sections, and other machined features that may be subject to wear or damage if contacted improperly.

During assembly and maintenance operations, plungers may be inserted into, or removed from, the bores of the fluid end. In certain maintenance environments, the fluid end may remain mounted in a horizontal orientation, and the plunger may be removed through a front opening of the fluid end. In such circumstances, the plunger may contact internal surfaces of the bore during removal or installation.

Contact between the plunger and internal surfaces of the bore, including insert sections and sealing regions, may result in surface damage or degradation. Surface damage to these regions may affect sealing integrity, service life, or operational performance of the fluid end. It is therefore desirable to protect the internal surfaces of the bore during assembly and maintenance operations to reduce surface damages.

### SUMMARY

The present application discloses a sleeve for use in removing and installing plungers in pump fluid ends. The sleeve comprises a body. The body comprises a first surface, a second surface, an inner surface, an outer surface, a longitudinal axis, and a passage. The second surface is opposed to the first surface. The outer surface is bound between the first surface and the second surface. The outer surface comprises a first section formed adjacent to the first surface, and a second section formed adjacent to the second surface. The first section is configured to engage a tapered surface formed in a fluid end housing. The second section is configured to engage a retainer thread formed in the fluid end housing. The inner surface is bound between the first surface and the second surface. The longitudinal axis extends between the first surface and the second surface. The passage is formed within the body and extends through both the first surface and the second surface. The body is removable from the fluid end housing.

The present application also discloses a sleeve configured for use during removal and installation of plungers in a high-pressure fluid end assembly. The sleeve comprises a tapered body. The tapered body comprises a first end, a second end, and a passage formed therein. The first end defines a first opening. The second end defines a second opening. The passage joins both the first and second openings. The sleeve is formed of a thermoplastic material.

The present application also discloses a protective sleeve for use during removal and installation of a plunger within a fluid end assembly. The protective sleeve comprises a tapered body. The tapered body comprises a front surface, a rear surface, an outer intermediate surface, an inner intermediate surface, and a bore. The rear surface is opposed to the front surface. The outer intermediate surface is bound between the front surface and the rear surface. The outer intermediate surface defines a non-linear profile such that a diameter of the outer intermediate surface at the front surface is greater than a diameter of the outer intermediate surface at the rear surface. The inner intermediate surface is bound between the front surface and the rear surface. The bore is formed in the tapered body. The bore traverses both the front surface and the rear surface. The sleeve is made of a thermoplastic material.

### BRIEF DESCRIPTION OF THE DRAWINGS

FIG. 1 is a top-front-right isometric view of a fluid end.

FIG. 2 is a cross-sectional view of FIG. 1, taken through plane A-A.

FIG. 3 is a detailed view of area B shown in FIG. 2.

FIGS. 4 is 3 , but with the flow control components removed to show the flow bore and insert.

FIG. 5 is a top-front-right isometric view of one embodiment of the protective sleeve disclosed herein.

FIG. 6 is a top-rear-left isometric view of the protective sleeve shown in FIG. 5.

FIG. 7 is a cross-sectional view of FIG. 5, taken through plane C-C.

FIGS. 8 is 4 , but with the protective sleeve shown in FIG. 5 installed therein.

FIG. 9 is a cross-sectional view of FIG. 1, taken through plane A-A, in which the flow control components have been removed, the protective sleeve shown in FIG. 5 has been installed, and an installation/removal tool has been threaded into the plunger, showing the position of the plunger just before beginning removal or just after full insertion.

FIGS. 10 is 9 , but with the plunger resting on the protective sleeve, showing the position of the plunger just before full removal or prior to being fully inserted.

FIG. 11 is a top-front-right isometric view of another embodiment of the protective sleeve disclosed herein.

FIG. 12 is a top-rear-left isometric view of the protective sleeve shown in FIG. 11.

FIG. 13 is a cross-sectional view of FIG. 11, taken through plane D-D.

FIGS. 14 is 4 , but with the protective sleeve shown in FIG. 11 installed therein.

### DETAILED DESCRIPTION

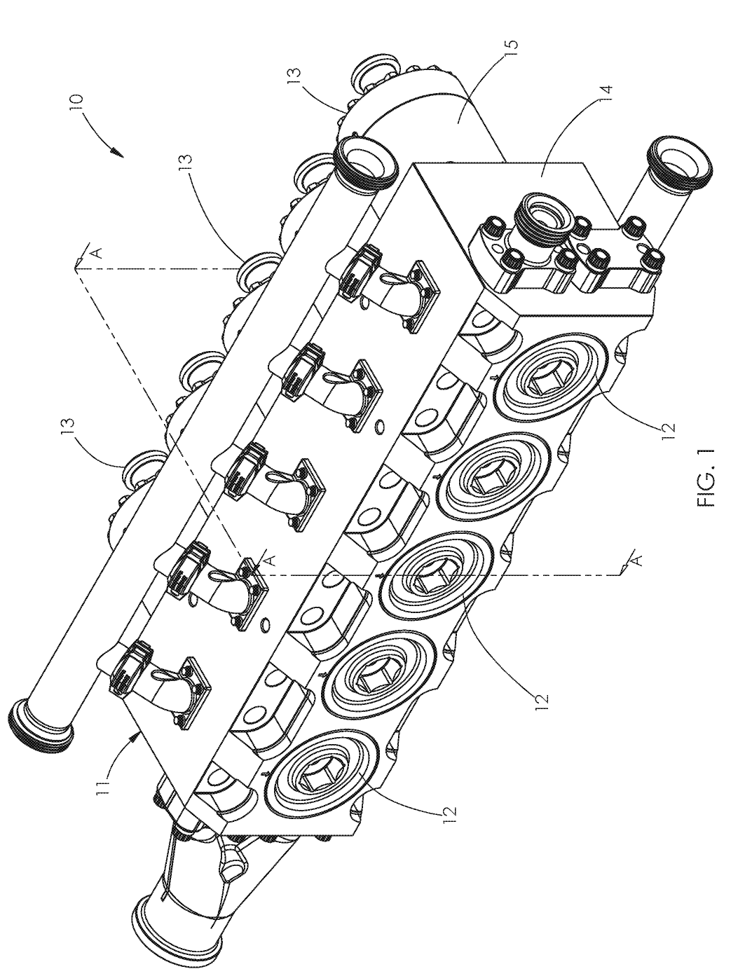

A fluid end 10, shown in FIGS. 1-3, includes a fluid end body 11, a plurality of flow control systems 12, and a plurality of plunger systems 13. The fluid end body 11 includes a static section 14 and a plurality of dynamic sections 15.

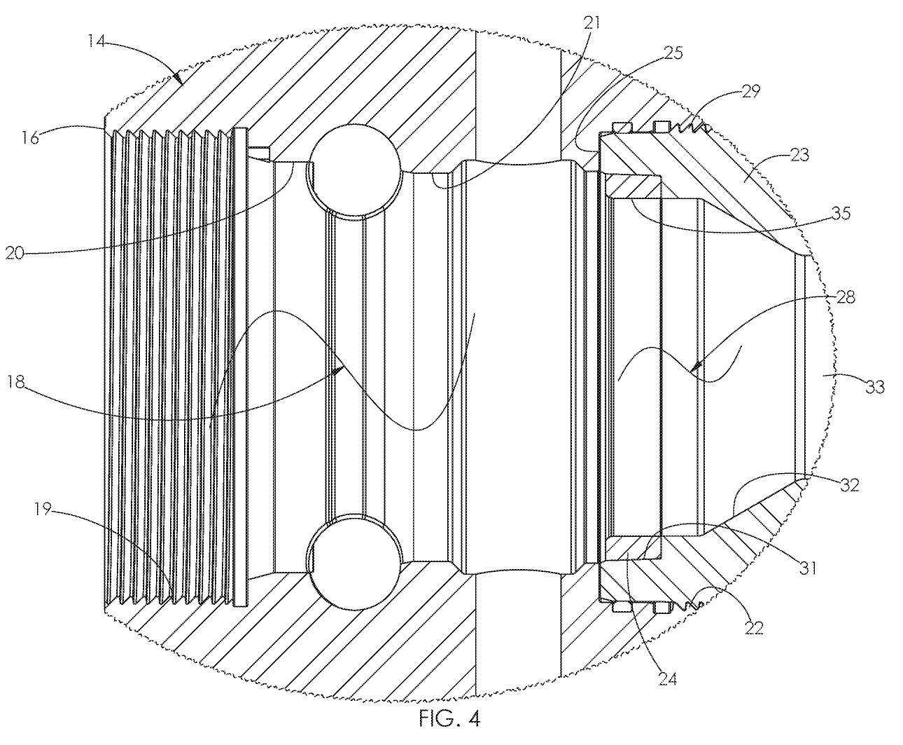

The static section 14 includes a front surface 16, an opposed rear surface 17, and a plurality of flow bores 18, shown in FIG. 4. Each flow bore 18 is evenly spaced transversely and centered vertically within the static section 14. Each flow bore 18 is a through-bore that extends between the front and rear surfaces 16, 17 of the static section 14. Each flow bore’s axis is parallel to the longitudinal axis. Each flow bore 18 is configured to receive a portion of a corresponding one of the flow control systems 12 on a one-to-one basis and to facilitate the attachment of a corresponding one of the dynamic sections 15 to the static section 14 on a one-to-one basis. Each flow bore 18 includes a retainer thread 19 near the front surface 16 of the static section 14, a discharge plug seal section 20, a front fluid routing plug seal section 21, and a dynamic thread 22 near the rear surface 17, shown in FIG. 4.

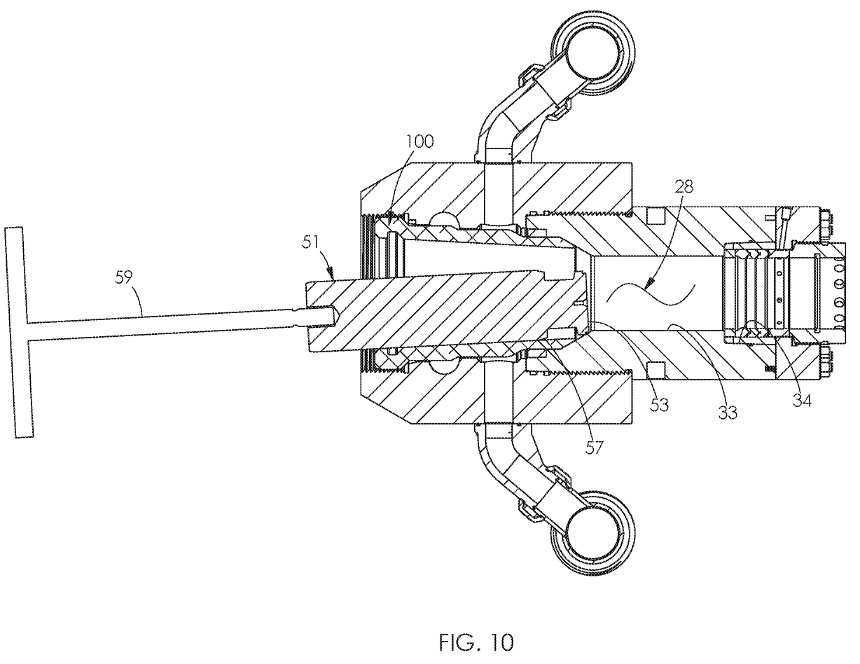

Each dynamic section 15 includes a dynamic body 23 and an insert 24. The dynamic body 23 is cylindrical and includes a front surface 25, an opposed rear surface 26, an outer surface 27, and a flow bore 28. The outer surface 27 includes static threads 29 and a locating shoulder 30. The flow bore 28 is concentric with the dynamic body 23 and extends between the front and rear surfaces 25, 26 of the dynamic body 23. The flow bore 28 includes an insert section 31, a flow control section 32, a plunger section 33, and a packing section 34, shown in FIGS. 4 and 10.

The insert 24 includes an inside diameter 35 and is formed of a material that is harder than the dynamic body 23. The material may be hardened steel, tungsten carbide, or any of the numerous materials designed to withstand wear due to constant abrasion, such as that applied by a rear fluid routing plug seal 43. A common property of these hardened materials is brittleness; they should not be subjected to impact, as this can cause breakage.

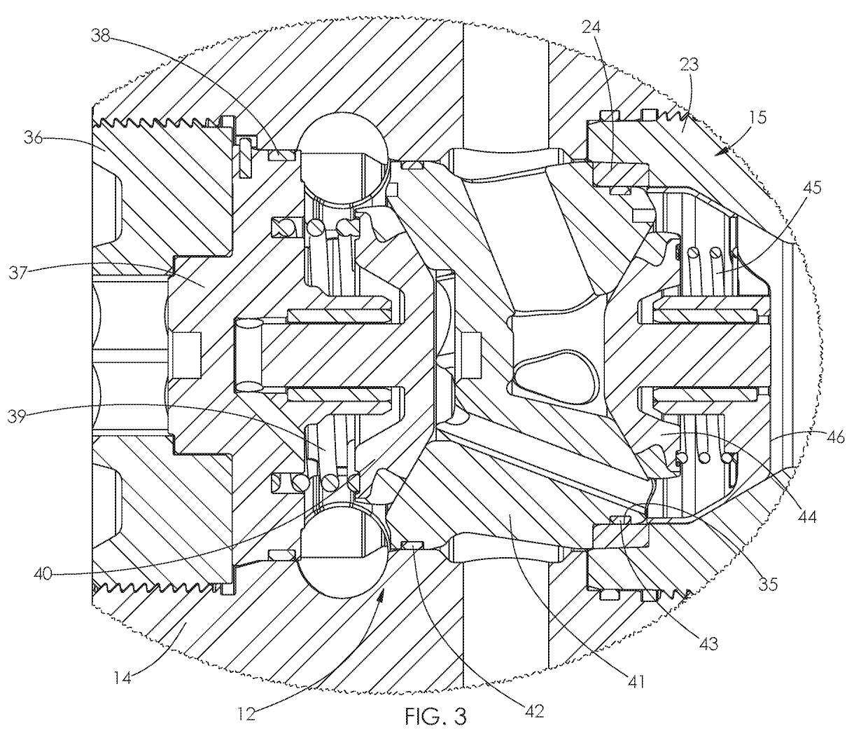

Each flow control system 12 shown in FIG. 3 includes a retainer 36, a discharge plug 37, a discharge plug seal 38, a discharge valve spring 39, a discharge valve 40, a fluid routing plug 41, a front fluid routing plug seal 42, a rear fluid routing plug seal 43, a suction valve 44, a suction valve spring 45, and a suction valve guide 46.

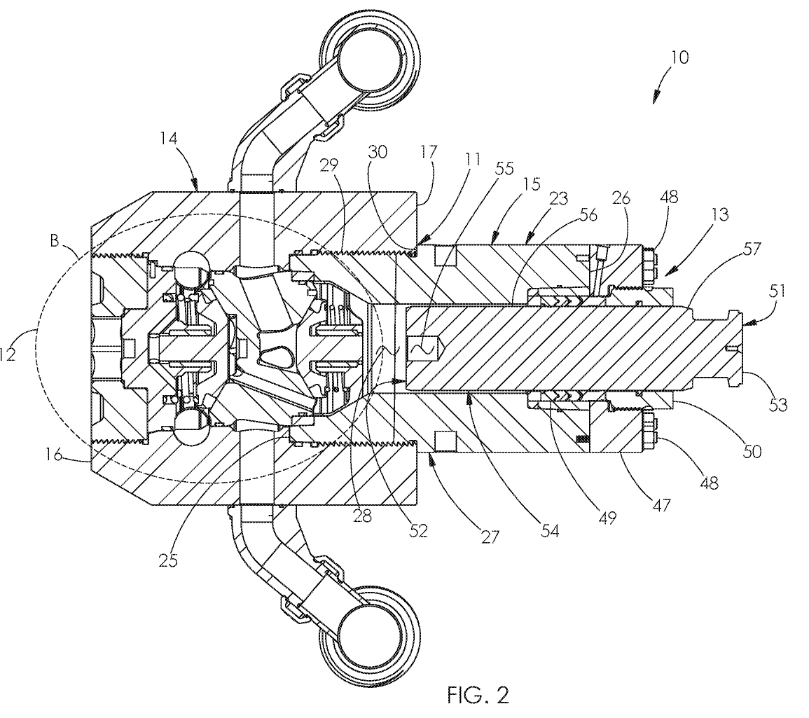

Each plunger system 13 shown in FIG. 2 includes a retainer 47, fasteners 48, a packing 49, a packing nut 50, and a plunger 51. The plunger 51 is cylindrical and includes a front surface 52, an opposed rear surface 53, and an outer surface 54. The front surface 52 includes a threaded blind bore 55 that is concentric with the plunger 51. The outer surface 54 includes a packing section 56 and an installation taper 57.

To illustrate the value of the disclosed invention, it is helpful to understand the different methods for assembling and disassembling the fluid end 10 depending on the physical location of the fluid end 10—whether in the field, at the facility of origin, or at a maintenance center. In all cases, dynamic sections 15 may be assembled prior to installation by pressing the insert 24 into the insert section 31 of the flow bore 28 of each dynamic body 23, as shown in FIG. 4.

When the fluid end 10 is assembled at the facility of origin or at a maintenance center, the fluid end 10 is not connected to a power end, and equipment is available to orient the components for ease of assembly. In this scenario, the static section 14 is oriented such that the bore axis of each flow bore 18 is vertical, with the dynamic threads 22 positioned at the top of the static section 14. The dynamic sections 15 are then threaded into the dynamic threads 22, which simplifies alignment and facilitates thread engagement.

Referring now to FIG. 2, once the dynamic sections 15 are in place, the retainer 47 is attached to the rear surface 26 of the dynamic sections 15 using the fasteners 48. The packing 49 and the packing nut 50 are installed, but the packing nut 50 is not yet tightened. The plunger 51 is then installed into the flow bore 28 from the rear of the dynamic body 23, passing through the packing 49. This approach avoids inserting the plunger 51 from the front of the static section 14, which would otherwise require passing it through the flow bores 18 and insert 24, thereby risking damage to the sealing surfaces of the flow bores 18 of the static section 14 or breakage of the insert 24.

With the plunger 51 installed, the flow control systems 12 components are inserted into the flow bores 18 of the static section 14 from its front surface 16. To minimize the risk of damaging the seal surfaces 20, 21 of the flow bores 18, the fluid end 10 may be reoriented with the retainer threads 19 facing upward. This orientation equalizes the effects of gravity, allowing the flow control systems 12 components to be lowered into place within the flow bores 18.

Finally, the packing nut 50 is tightened to apply the appropriate axial force to the packing 49. This force provides sealing engagement between the packing 49 and the flow bore 28 of the dynamic body 23, as well as between the packing 49 and the outer surface 54 of the plunger 51.

Having now described the assembly of the fluid end 10 in the ideal facility setting, the following sections describe disassembly and reassembly in the field. This includes the use of the present invention, illustrating its advantages in less controlled environments.

When maintenance of the fluid end 10 components is required in the field, the fluid end 10 typically remains connected to the power end, as disconnecting it would be labor-intensive and impractical. This constraint necessitates that the fluid end 10 remain in a horizontal orientation during maintenance. As a result, any servicing requiring the removal of the plunger 51 will mean that the plunger 51 be removed from the front surface 16 of the static section 14.

Because the plunger 51 is removed through the front surface 16 of the static section 14, it passes along the entire length of the flow bores 18, 28 and past the insert 24. Given the weight of the plunger 51, a technician is unlikely to be able to support it sufficiently to keep it centered in the flow bores 18, 28 during removal. Consequently, the plunger 51 will tend to rest on and drag along the bottom of the flow bores 18, 28, increasing the risk of contact with the insert 24 and the sealing surfaces 20, 21, potentially causing damage. To mitigate this risk, a protective sleeve 100 is used to shield the insert 24 and the sealing surfaces 20, 21 during both disassembly and reassembly.

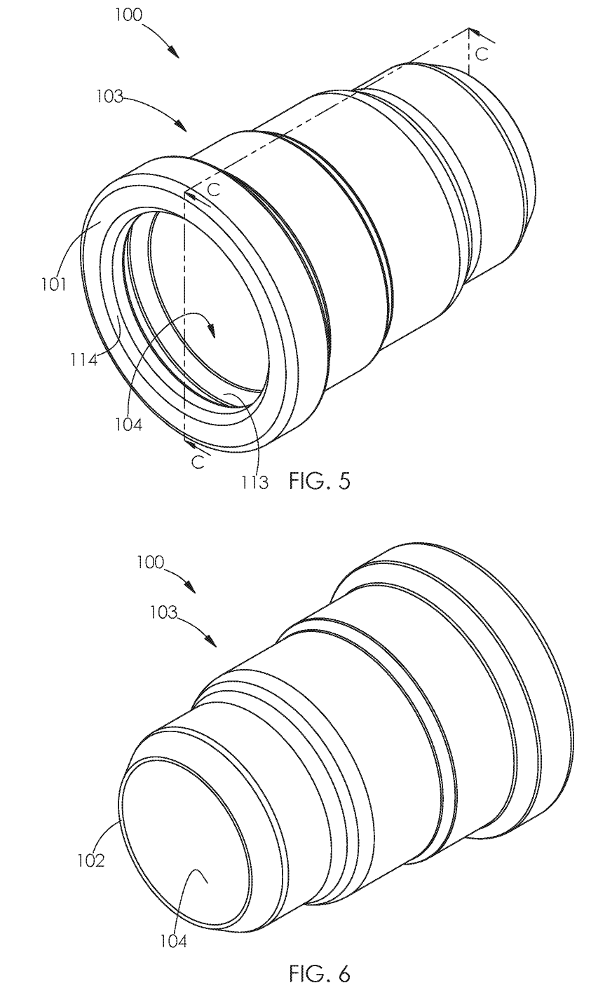

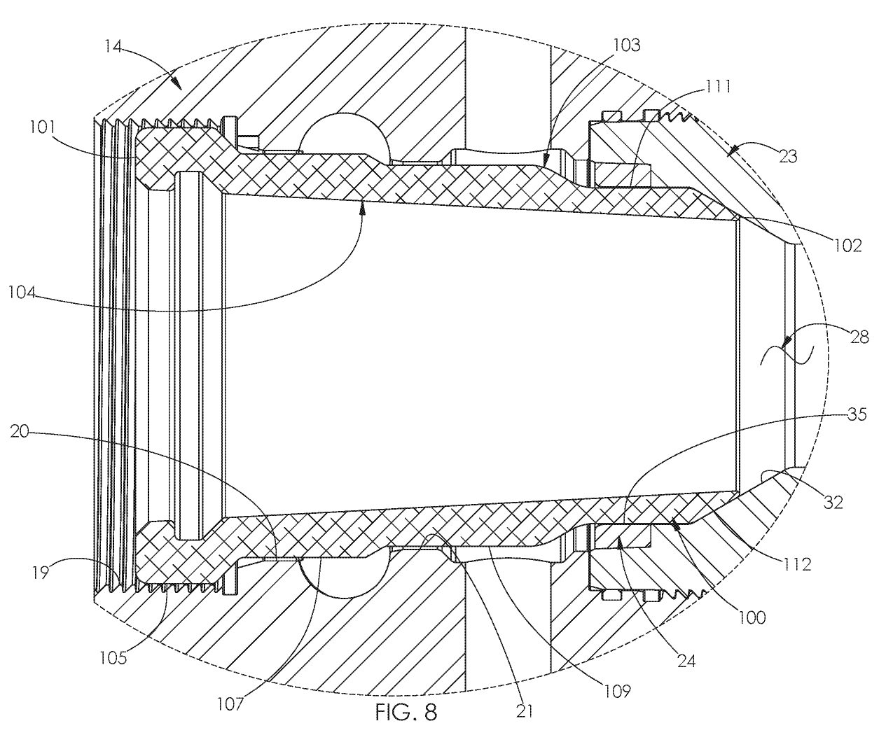

A protective sleeve 100, shown in FIGS. 5-7, is generally cylindrical and includes a front surface 101, an opposed rear surface 102, an outer surface 103, and an inner surface 104. The outer surface 103 may include a plurality of unequal diameter sections that are complementary to the internal profile of the flow bores 18 of the static section 14, the inside diameter 35 of the insert 24, and the flow bore 28 of the dynamic section 15, as shown in FIG. 8. The outer surface 103 may further include a plurality of transition sections, each between adjacent diametrical sections to accommodate changes in diameter along the length of the protective sleeve 100.

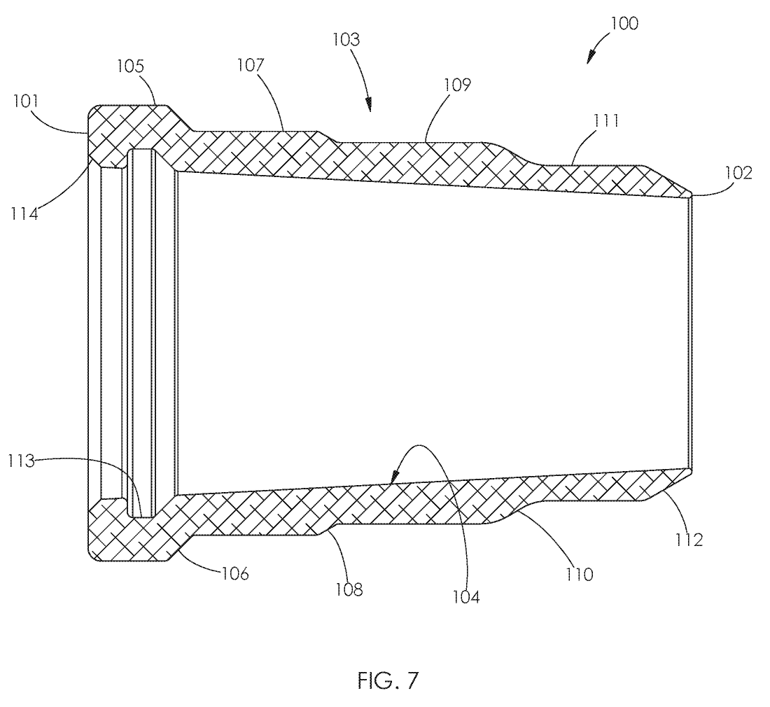

Specifically, beginning at the front surface 101 and continuing to the rear surface 102, the outer surface 103 of the embodiment shown includes a retainer thread section 105, a first transition section 106, a discharge plug seal section 107, a second transition section 108, a front fluid routing plug seal section 109, a third transition section 110, an insert section 111, and a flow control section 112, as shown in FIG. 7.

The inner surface 104 of the protective sleeve is tapered in a reducing diameter from the front surface 101 toward the rear surface 102, such that the inner diameter is larger at the front surface 101 and decreases toward the rear surface 102, thereby guiding the plunger 51 into the plunger section 33 of the flow bore 28 of the dynamic body 23 during insertion, as shown in FIG. 10. The inner surface 104 further includes a groove 113 proximate the front surface 101 to facilitate removal of the protective sleeve 100. This groove 113 may have various detailed profiles but, at its core, provides a recessed feature capable of engagement for removal of the protective sleeve 100 from the flow bores 18. Importantly, the groove 113 is entirely internal and recessed, such that no portion of the groove 113 projects radially inward beyond the tapered inner surface 104. This ensures that the plunger 51 can be inserted and removed without interference. The inner surface 104 may also include an entry chamfer 114 to aid in the initial insertion of the plunger 51.

In this embodiment, the protective sleeve 100 may be formed from a durable material selected for toughness and resistance to impact. Suitable materials may include thermoplastic materials such as polyamide (nylon) or polycarbonate, or other materials having a hardness less than that of the insert 24 and the sealing surfaces 20, 21. The selected material may be capable of withstanding repeated insertion and removal while reducing the likelihood of damage to adjacent components.

To disassemble, first remove the retainer 36 from the retainer thread 19 of the flow bores 18 of the static section 14. Then, remove the remaining flow control components, leaving the flow bore 18 of the static section 14 empty, as shown in FIG. 4. Next, install the protective sleeve 100, as shown in FIG. 8. The outer diameters 105, 107, 109, and 111 of the outer surface 103 of the protective sleeve 100 closely engage the respective portions 19, 20, and 21 of the flow bore 18 of the static section 14, the inside diameter 35 of the insert 24, and the flow control section 32 of flow bore 28 of the dynamic body 23.

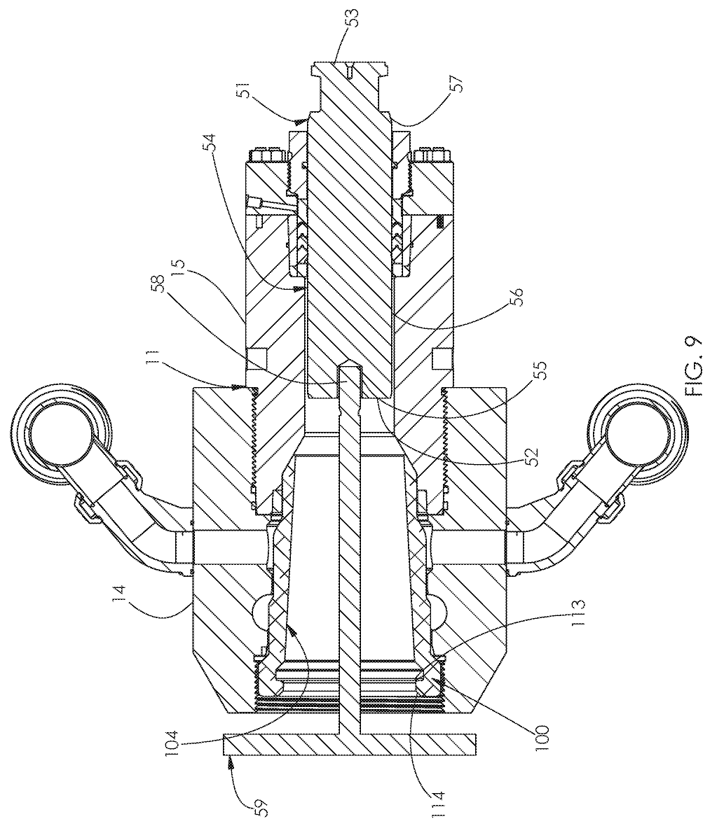

After installing the protective sleeve 100, loosen or remove the packing nut 50 to reduce the radial force of the packing 49 on the plunger 51, making it easier to remove. Next, thread the threaded end 58 of a plunger removal tool 59 into the threaded blind bore 55 on the front surface 52 of plunger 51, as shown in FIG. 9. Use the plunger removal tool 59 to remove the plunger 51. As the plunger 51 is removed, it will rest on the protective sleeve 100 rather than the insert 24 or sealing sections 20, 21 of the flow bore 18, as shown in FIG. 10. At this point the packing 49 may be replaced, and other inspections or services may be performed as needed.

For reassembly, first install the packing 49, then thread the packing nut 50 into the retainer 47, but do not tighten it yet. Next, thread the plunger removal tool 59 into the threaded blind hole 55 on the front surface 52 of the plunger 51. If the plunger 51 was removed previously, it may still be installed from the disassembly process, but if a new plunger 51 is being used, this step will need to be completed. Then, lift the plunger 51 into the protective sleeve 100 and slide it rearward until the rear surface 53 or installation taper 57 engages the plunger section 33 of the flow bore 28 of the dynamic body 23, as shown in FIG. 10. As the plunger 51 is pushed rearward, the installation taper 57 will engage the packing 49 and guide the plunger 51 to its concentric position within the flow bores 18, 28, as shown in FIG. 9. Finally, using the groove 113 on the inner surface 104 of the protective sleeve 100, remove the protective sleeve 100 from the flow bores 18, 28. Once the protective sleeve 100 is removed, install the flow control system 12 components. Tighten the packing nut 50 to engage the packing 49 to the dynamic body 23 and the plunger 51.

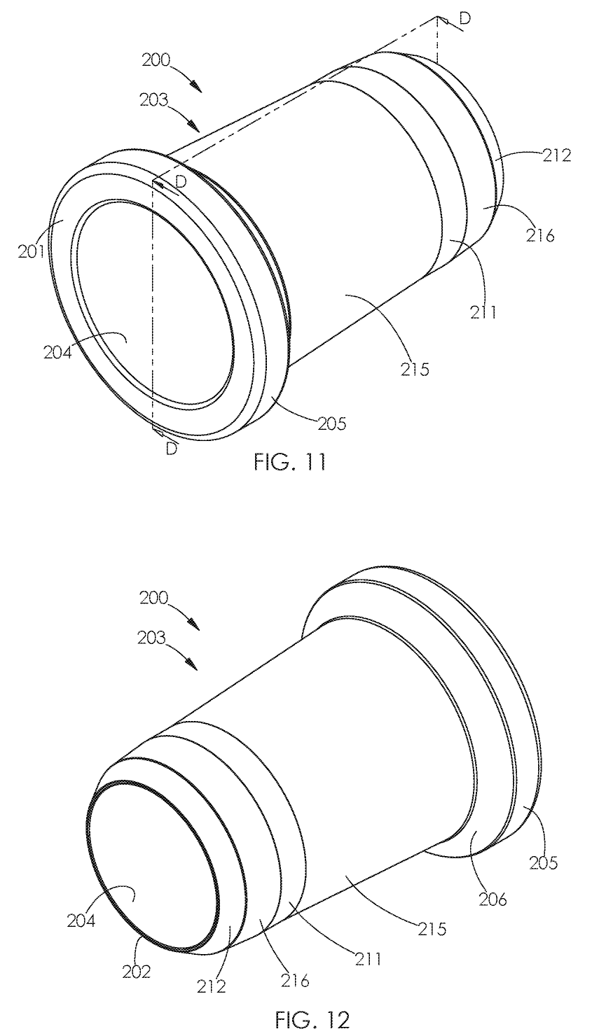

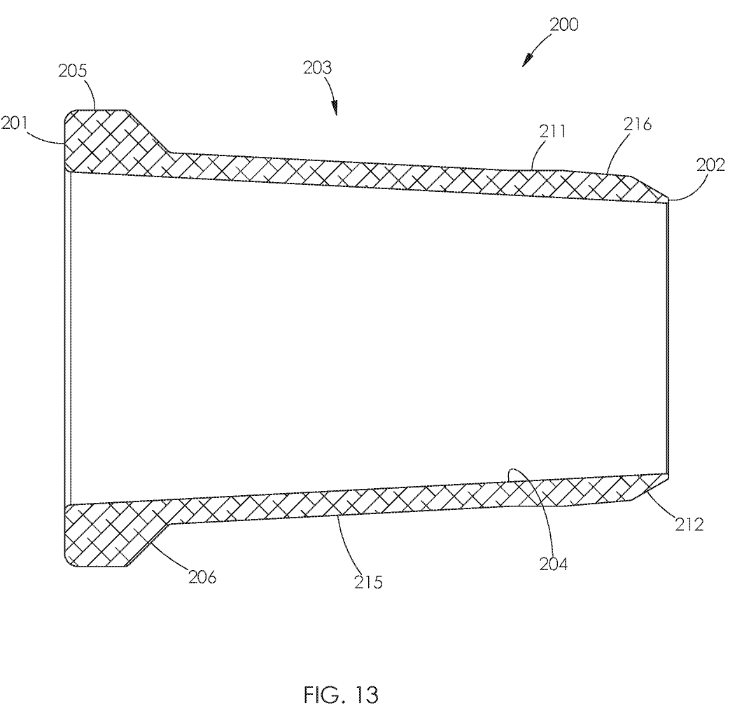

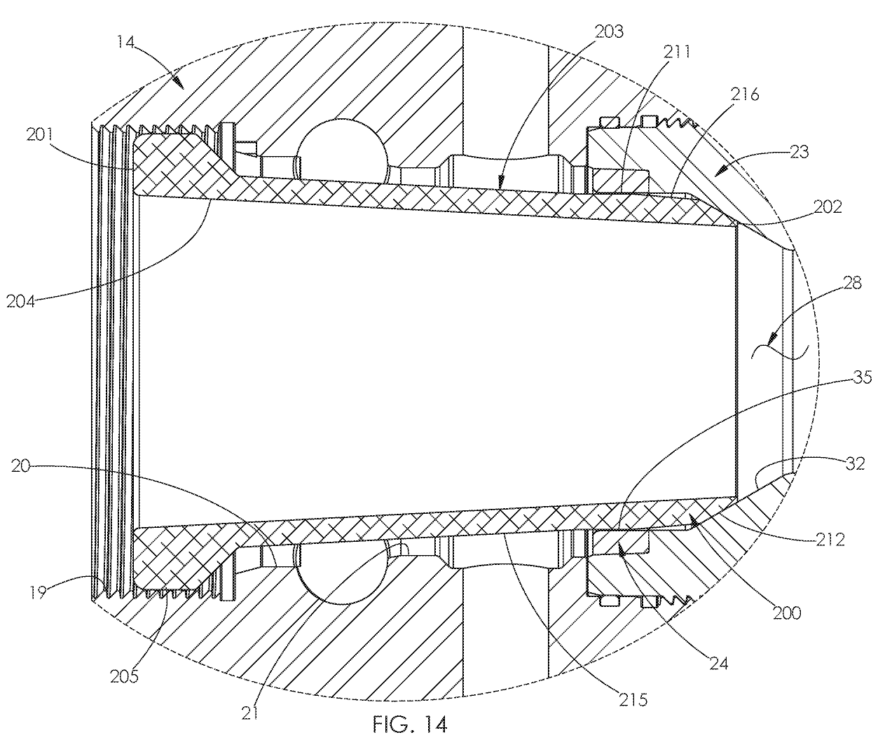

Another embodiment of a protective sleeve 200 is shown in FIGS. 11-14. The protective sleeve 200 is generally cylindrical and includes a front surface 201, an opposed rear surface 202, an outer surface 203, and an inner surface 204. The protective sleeve 200 defines a longitudinal axis extending between the front surface 201 and the rear surface 202.

Beginning at the front surface 201 and proceeding toward the rear surface 202, the outer surface 203 includes a retainer thread section 205, a first transition section 206, a first tapered section 215, an insert section 211, a second tapered section 216, and a flow control section 212 terminating at the rear surface 202. One or more radii or chamfers may be provided at transitions between adjacent sections of the outer surface 203 and at intersections of the outer surface 203 with the front surface 201 and the rear surface 202.

In this embodiment, the retainer thread section 205 may have a maximum outer diameter of approximately 8.7 inches, and the insert section 211 may have a maximum outer diameter of approximately 6.4 inches. The first transition section 206, the first tapered section 215, the second tapered section 216, and the flow control section 212 may extend at angles measured relative to the longitudinal axis. For example, the first transition section 206 may extend at approximately 45 degrees, the first tapered section 215 at approximately 3 degrees, the second tapered section 216 at approximately 5 degrees, and the flow control section 212 at approximately 30 degrees, each relative to the longitudinal axis. These angular and dimensional values are provided as non-limiting examples.

The inner surface 204 tapers from a larger inner diameter adjacent the front surface 201 to a smaller inner diameter adjacent the rear surface 202. The taper may extend at a substantially constant angle relative to the longitudinal axis, for example approximately 3 degrees relative to the longitudinal axis. One or more radii or chamfers may be provided at intersections of the inner surface 204 with the front surface 201 and the rear surface 202.

The protective sleeves 100 and 200 may be used with fluid end assemblies having different bore geometries, insert configurations, and plunger diameters. The outer surfaces 103, 203 may include cylindrical sections, tapered sections, transition sections, or combinations thereof arranged in various axial sequences. The inner surfaces 104, 204 may include tapered surfaces, cylindrical surfaces, or combinations thereof extending between the respective front and rear surfaces. Dimensional relationships between the protective sleeve and corresponding portions of the flow bores 18, the insert 24, and the flow bore 28 may be selected to provide clearance, sliding engagement, radial alignment, or other relative positional relationships.

The protective sleeves 100, 200 may be formed as single-piece bodies or as multiple components secured together. The protective sleeves 100, 200 may be formed from materials having a hardness less than that of the insert 24 and the sealing surfaces 20, 21, including thermoplastics, thermoset polymers, composite materials, or non-hardened metals.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A sleeve for use in removing and installing plungers in pump fluid ends, the sleeve comprising:
a body, comprising:
a first surface;
a second surface, wherein the second surface is opposed to the first surface;
an outer surface bound between the first surface and the second surface, the outer surface comprising:
a first section formed adjacent the first surface; and
a second section formed adjacent the second surface;
in which the first section is configured to engage a tapered surface formed in a fluid end housing; and
in which the second section is configured to engage a retainer thread formed in the fluid end housing;
an inner surface bound between the first and second surfaces;
a longitudinal axis extending between the first surface and the second surface; and
a passage formed within the body and extending through both the first and second surfaces;
in which the body is removable from the fluid end housing; and
in which the passage is configured to receive a plunger.

2. The sleeve of claim 1, in which the fluid end housing is made of a first material and the sleeve is made of a second material, in which the first material is harder than the second material.

3. The sleeve of claim 1, in which the sleeve is formed from a thermoplastic material.

4. A kit, comprising:
the sleeve of claim 1; and
a fluid end assembly, comprising:
a fluid end housing which is the fluid end housing of claim 1; and
a hardened insert disposed in the fluid end housing;
in which the hardened insert is made of an insert material; and
in which the insert material is harder than a material used to form the fluid end housing.

5. The kit of claim 4, in which the sleeve is made of a sleeve material; in which the material used to form the fluid end housing is harder than the sleeve material.

6. The sleeve of claim 1, in which the body tapers such that the first section has a first maximum diameter and the second section has a second maximum diameter; in which the second maximum diameter is greater than the first maximum diameter.

7. The sleeve of claim 1, in which the inner surface is tapered in a reducing diameter from the second surface to the first surface.

8. A method of removing and reinstalling a reciprocating plunger from a high-pressure fluid end assembly, the method comprising:
removing flow control components from a flow bore formed in a high-pressure fluid end assembly;
inserting the sleeve of claim 1 into the flow bore; and
removing a reciprocating plunger from the high-pressure fluid end assembly through the passage of the sleeve.

9. The method of claim 8, further comprising:
threading a plunger removal tool into a threaded blind bore formed on the reciprocating plunger;
manipulating the reciprocating plunger using the plunger removal tool; and
unthreading the plunger removal tool from the threaded blind bore.

10. A sleeve configured for use during removal and installation of plungers in a high-pressure fluid end assembly, the sleeve comprising:
a tapered body, comprising:
a first end defining a first opening;
a second end defining a second opening; and
a passage formed therein, wherein the passage joins the first opening and the second opening;
in which the sleeve is formed from a thermoplastic material.

11. The sleeve of claim 10, in which the tapered body further comprises:
an outer surface bound between the first end and the second end, wherein the outer surface has a non-linear profile.

12. The sleeve of claim 11, in which the outer surface comprises:
a first section formed adjacent the first end, wherein the first section comprises a first maximum diameter;
a second section formed adjacent the first section, wherein the second section comprises a second maximum diameter; and
a third section formed adjacent the second end, wherein the third section comprises a third maximum diameter;
in which the second section is situated intermediate the first section and the third section;
in which the second maximum diameter is greater than the first maximum diameter; and
in which the third maximum diameter is greater than the second maximum diameter.

13. The sleeve of claim 12, in which the third section of the outer surface is configured to engage a threaded retainer surface of a fluid end housing.

14. The sleeve of claim 12, in which the first section of the outer surface is configured to engage a tapered wall formed within a fluid end housing; and in which the first section of the outer surface is configured to prevent axial movement of the sleeve within the fluid end housing.

15. The sleeve of claim 10, in which the tapered body further comprises:
an inner surface bound between the first end and the second end, wherein the inner surface has a linear profile.

16. The sleeve of claim 10, in which the tapered body is thicker at the second end than at the first end.

17. A protective sleeve for use during removal and installation of a plunger within a fluid end assembly, the protective sleeve comprising:
a tapered body, comprising:
a front surface;
a rear surface, wherein the rear surface is opposed to the front surface;
an outer intermediate surface bound between the front surface and the rear surface, wherein the outer intermediate surface defines a non-linear profile such that a diameter of the outer intermediate surface adjacent to the front surface is greater than a diameter of the outer intermediate surface adjacent to the rear surface;
an inner intermediate surface bound between the front surface and the rear surface; and
a bore formed in the tapered body, wherein the bore traverses both the front surface and the rear surface;
in which the sleeve is made of a thermoplastic material.

18. The protective sleeve of claim 17, in which the inner intermediate surface defines a tapered linear profile.

19. The protective sleeve of claim 17, in which the outer intermediate surface comprises:
a first section formed adjacent the front surface;
in which the first section is configured to abut a walled surface of a fluid end housing; and
in which the first section is configured to prevent axial movement of the protective sleeve within the fluid end housing.

20. A method of performing maintenance on a fluid end assembly, the method comprising:
installing the protective sleeve of claim 17 within a fluid end bore of a fluid end housing; and
removing a plunger from the fluid end housing such that the plunger rests against the protective sleeve.
